(19) United States
(12) Patent Application Publication
(10) Pub. No.: US 2002/0138558 A1
(43) Pub. Date: Sep. 26, 2002

(54) Managing and processing print jobs in a networked computer environment

(76) Inventor: Andrew R. Ferlitsch, Tigard, OR (US)

Correspondence Address: Michael F. Krieger, Kirton & McConkie, 1800 Eagle Gate Tower, 60 East South Temple, Salt Lake City, UT, 84111, US

(21) Appl. No.: 10/008,423

(22) Filed: Nov. 13, 2001

Related U.S. Application Data
(60) Provisional application No. 60/261,132, filed on Jan. 11, 2001.

(51) Int. Cl. G06F 15/16; H04N 1/00

(52) U.S. Cl. 709/203; 358/400

(57) ABSTRACT

Systems and methods for managing and processing print jobs in a networked computer environment without using a print server. In a computer system configuration that includes one or more clients connected to one or more printers via a network, a client is configured to manage print jobs initiated by that client and optionally to manage print jobs initiated by other clients. In managing and processing print jobs, the clients utilize a broadcast that is transmitted across the network for a variety of purposes, such as to register a client in a distributed management of print jobs, to indicate an intent to despool a print job, to set or check the status of a despooled print job, to set or get the status of a particular printing device, to request print queue information, and/or to request a print queue change. A local spooler or print processor initiates such broadcasts to enable the managing and processing of print jobs.

### RELATED APPLICATION

This application claims priority to U.S. patent application Ser. No. 09/681,409 filed Mar. 30, 2001, entitled “METHODS AND SYSTEMS FOR PRINT-PROCESSOR-BASED PRINTER STATUS DETECTION AND PRINT TASK DISTRIBUTION,” and to U.S. patent application Ser. No. 09/681,416 filed Mar. 30, 2001, entitled “METHODS AND SYSTEMS FOR PRINT-PROCESSOR-BASED PRINT TASK ERROR RECOVERY,” both of which claim priority to U.S. patent application Ser. No. 09/681,208 filed Feb. 22, 2001, entitled “METHODS AND SYSTEMS FOR PRINT-PROCESSOR-MODIFIED PRINTING,” which claims priority to U.S. Provisional Patent Application Serial No. 60/261,132 filed Jan. 11, 2001, entitled “METHODS AND SYSTEMS FOR PRINT-PROCESSOR-MODIFIED PRINTING.”

### BACKGROUND OF THE INVENTION

1. Field of the Invention

The present invention relates to printing a document in a computer system configuration. In particular, the present invention relates to systems and methods for managing and processing print jobs in a networked computer environment without using a print server.

2. Background and Related Art

With the emergence of software and hardware components of computer systems, users are able to employ the systems to perform a variety of tasks. For example, a user may utilize a software application, such as a word processor, spreadsheet, or other application, to create a file or document. Once created, the document may be printed on a local or network printing device.

In a computer system that includes various client computer devices and a printing device connected via a network, the utilization of the networked system to print a file or document traditionally includes the use of print queues on a centralized computing device, commonly referred to as a print server. A print queue lines up print jobs for a particular network printing device. Thus, for example, when a number of documents are to be printed by a network printer, the documents are ordered in a print queue on the print server and pulled one at a time off the queue for printing. Print jobs are commonly executed in the same order that they were placed on the print queue, but may be prioritized based on other criteria, such as by the size or type of the documents that are to be printed.

When a user initiates a print command at one of the client computer devices, the client despools print data for the print job to a print queue that is located on a print server and that is associated with a corresponding network printer. When it is time to remove the print job from the queue, the print server despools the print data from the print queue to the network printer. While this method for network printing enables a variety of client computer devices to utilize a network printer, the method requires a large amount of network traffic since the print data of each print job must be despooled twice over the network. Furthermore, the traditional method causes a loss of bi-directional communication, resulting in a loss of error handling and/or a loss of job completion notices. Moreover, the traditional method requires the use of an additional computer device (the print server), which causes an increase in hardware costs and maintenance.

Other methods include using a print provider at the client to open a connection to the network printer through the use of a particular protocol, such as TCP/IP, Novell Netware, or Apple Talk, and attempting to spool data directly to the printer. However, since a network printer is commonly shared among a variety of clients, the printer must serialize the spooling and printing of print jobs that arrive simultaneously. As such, the printer must cause subsequent attempts to despool print data and must block one print job while another print job is being printed. Alternatively, one print job is despooled into firmware memory or onto a disk drive at the printer while another print job is being printed. These methods cause the client computer device to consume CPU cycles and/or to generate additional network traffic. Furthermore, there is no centralized management of the print jobs and thus no prioritization as to the order in which the print jobs are processed.

One attempt to reduce the amount of network traffic required in performing network printing includes an operating system at the client that allows journaled data to be despooled to the print queue rather than the traditional rendered data. The amount of joumaled data is assumed to be less in comparison to the amount of traditional rendered data. Therefore, the amount of network traffic is reduced. However, this attempt requires a copy of the corresponding printer driver to be located on the print server. The execution of the printer driver and corresponding consumption of central processing unit (“CPU”) cycles on the print server render the joumaled data. This attempt requires requiring the maintenance and/or licensing of an extra printer driver, and does not address the loss of bi-directional communication or the requirement of an additional computer device, the print server.

### SUMMARY OF THE INVENTION

The present invention relates to printing a document in a computer system configuration. In particular, the present invention relates to systems and methods for managing and processing print jobs in a networked computer environment without using a print server.

Implementation of the present invention takes place in association with a computer system configuration that includes one or more clients connected to one or more printers via a network. A particular client is configured to manage print jobs initiated by that client and optionally to manage print jobs initiated by other clients. In managing and processing print jobs, the clients utilize a broadcast that is transmitted across the network for a variety of purposes, including to register a client in a distributed management of print jobs, to indicate an intent to despool a print job, to set or check the status of a despooled print job, to set or get the status of a particular printing device, to request print queue information, and/or to request a print queue change.

When processing a print job, a user initiates the print job at a particular client using an application or other process. The user may optionally select to split the job among available printers or to use a particular printer to process the job. In one implementation of the present invention, the print job is spooled from a print driver to a spooler, which is enabled to broadcast a message across the network. The spooler places the print job on a print queue local to the client, broadcasts a message indicating an intent to process the print job, and manages the print job until it is despooled to the printing device.

Once the client has been granted the opportunity to despool the print data to a printer across the network, the client's spooler despools the print data from the print queue to a print processor in one implementation of the present invention. In this implementation, if the print data is in a printer-ready format, the print processor sends the print data to the specified printer across the network. Alternatively, if the print data is in a journaled format, the print processor plays back the journaled data to the respective printer driver, and the print data is spooled to the spooler and then despooled to the specified printer across the network. The spooler updates the status of the print job on the print queue, removes the print queue entry, and sends a broadcast message to set the status of print jobs to receiving clients to eliminate any entries of the print job on remote queues.

In another implementation, a print processor is enabled to broadcast a message across the network. The print data is spooled from a print driver to the spooler and then despooled to the print processor, which places the print job on a print queue local to the client. Alternatively, the spooler may communicate an intent to despool the print data to the print processor without despooling the print data, and the print processor directs the spooler in placing the print job on a print queue that is local to the client.

Once the client has been granted the opportunity to despool print data to a printer across the network, the client's print processor despools the print data from the print queue. If the print data is in a printer-ready format, the print processor sends the print data directly to the specified printer. Alternatively, if the print data is in a journaled format, the print processor plays back the journaled data to the respective printer driver. The print data is spooled to the spooler and then despooled to the specified printer. The print processor, or a spooler that is directed by the print processor, updates the status of the print job on the print queue, removes the print queue entry, and sends a broadcast message to set the status of print jobs at receiving clients and to eliminate any entries of the print job on remote queues.

In alternative embodiments, a print driver or a print assistant may perform the management of queuing broadcast messages. The print assistant may be located anywhere in the printing subsystem. By way of example, the print assistant may be connected to a spooler, which is connected to a print processor, which is connected to a port.

While the methods and processes of the present invention have proven to be particularly useful in relation to print jobs, those skilled in the art can appreciate that the methods and processes can be used in a variety of different applications to perform peer to peer processes across a networked environment.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates a representative networked system configuration to implement an embodiment for managing and spooling print data over the network in accordance with the present invention;

FIG. 3 provides a flow chart that illustrates a representative embodiment for responding to a broadcast sent by a client across the network;

FIG. 4 provides a flow chart that illustrates a representative embodiment for using a broadcast as part of a process for performing a print job across the network; and

FIG. 5 provides a flow chart that illustrates a representative embodiment for despooling print data across the network.

### DETAILED DESCRIPTION OF THE INVENTION

The present invention relates to printing a document in a computer system configuration. In particular, the present invention relates to systems and methods for managing and processing print jobs in a networked computer environment without using a print server.

Embodiments of the present invention embrace a computer system configuration that includes one or more clients connected to one or more printers via a network. A client in the networked environment is configured to manage print jobs initiated by the client and optionally to manage print jobs initiated by other clients.

Management of print jobs includes initiating and/or receiving a broadcast that is transmitted across the network. The broadcast may be used for a variety of management purposes, including to register a client in a distributed management of print jobs, to indicate an intent to despool a print job, to set or check the status of a despooled print job, to set or get the status of a particular printing device, to request print queue information, and/or to request a print queue change, as will be further discussed below.

The following disclosure of the present invention is grouped into two subheadings, namely “Exemplary Operating Environment,” and “Managing and Processing Print Jobs in a Networked Environment.” The utilization of the subheadings is for convenience of the reader only and is not to be construed as limiting in any sense.

### EXEMPLARY OPERATING ENVIRONMENT

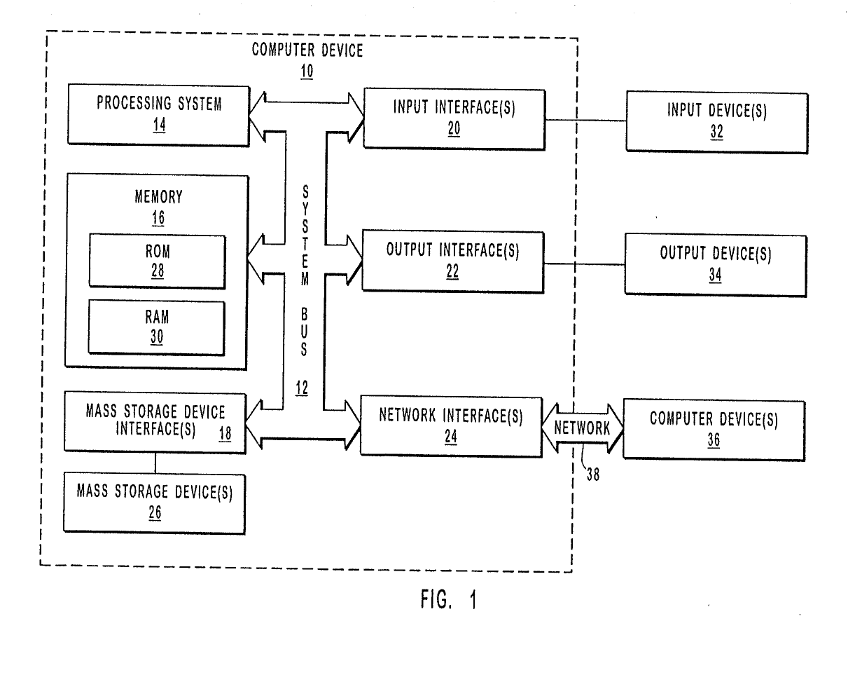

FIG. 1 and the corresponding discussion are intended to provide a general description of a suitable operating environment in which the invention may be implemented. One skilled in the art will appreciate that the invention may be practiced by a variety of computing devices and in a variety of system configurations, including in a networked configuration, as will be further explained below.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

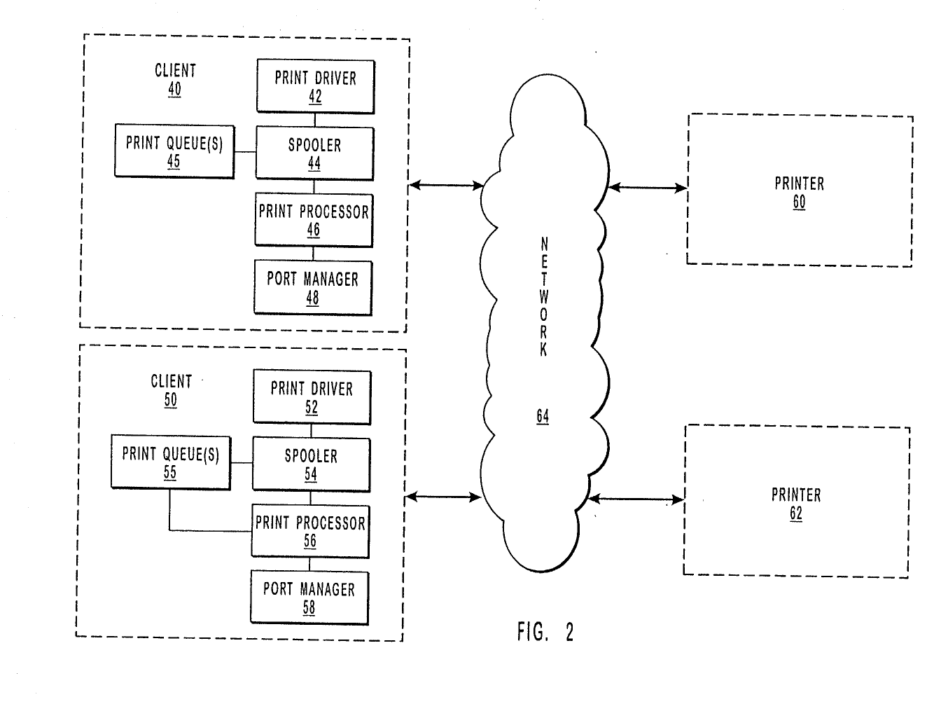

While those skilled in the art will appreciate that the invention may be practiced in networked computing environments with many types of computer system configurations, FIG. 2 represents an embodiment of the present invention in a networked environment that includes two clients and two printers connected via a network. While FIG. 2 illustrates an embodiment that includes two clients connected to the network, alternative embodiments include one client connected to a network or many clients connected to a network. Similarly, embodiments of the present invention include one printer connected to the network or more than two printers connected to the network.

The representative system illustrated in FIG. 2 for managing and processing print jobs in a networked environment includes a variety of computer devices, illustrated as clients 40 and 50, and one or more printing devices, illustrated as printers 60 and 62, connected via a network 64, which may include one or more local area networks (“LANs”) and/or one or more wide area networks (“WANs”). While printers 60 and 62 are illustrated as individual printers, an embodiment of the present invention embraces printer 60 or printer 62 as a cluster of printers that act as a single logical printing device as well as a single physical printing device.

Client 40 is a computer device that includes print driver 42, spooler 44, print queue(s) 45, print processor 46, and port manager 48. Similarly, client 50 is a computer device that includes print driver 52, spooler 54, print queue(s) 55, print processor 56, and port manager 58. Clients 40 and 50 are configured to manage print jobs initiated locally or remotely by other clients, as will be further discussed below.

Clients 40 and 50 keep one or more queues of spooled print jobs per accessible printing device. As an example, in the Microsoft® family of operating systems, spool data (<job>.spl) and spool header or shadow (.shd) files are kept in a spool directory (e.g., C:\windows\spool\printers) until despooled to the port manager(s) associated with the printing device(s), where <job> is the job identification associated with the print job. A client-based queue may be implemented by adding a third file to the spool directory to contain information about the print job to schedule and despool the print job at a later instant in time. By way of example, the information may include the DNS name of the printing device(s), the IP address of the printing device(s), the name of the document(s)/file(s) that are to be printed, the owner of the print job, a submission time of the print job, the size of the spool data, the number of pages in the print job, the number of sheets in the print job, the user, and/or an assigned priority for the print job.

An additional file may be kept in the spool directory, the registry, or in another location on disk or in memory that maintains an ordered list of spooled print jobs for each printing device. Each entry includes information for identifying the spool data, the header, and the queue information for a print job. In the Microsoft® family of operating systems, this information may be the file base name of the spool data file containing the print job identification. The position of each entry represents the current scheduled order for despooling among other spooled print jobs on the same print queue. Subsequent processing by a spooler, a print processor, or another application or background process may change the scheduling of existing spooled print jobs by changing the order of the corresponding enteries in the file.

While the discussion above relates to the use of a Microsoft® operating system, other embodiments of the present invention embrace the use of other operating systems, such as an Apple Macintosh® operating system, a Linux® operating system, a System V Unix® operating system, a BSD Unix® operating system, an OSF Unix® operating system, an IBM® Mainframe MVS operating system, and/or another operating system.

### Managing and Processing Print Jobs in a Networked Environment

A user at a client of a computer system configuration, through the use of a software application or other process at the client, initiates a print job. The user may, for example, select to split the print job among available printers on a network, select to use a particular printer based on a capability to process the print job, or select to use a printer based on the printer's current availability to process the print job.

In managing and processing the print job in accordance with the present invention, a broadcast is utilized that is transmitted across the network. The broadcast may follow one of a variety of formats, including Transmission Control Protocol/Internet Protocol (“TCP/IP”), Internet Printing Protocol (“IPP”), Hyper-Text Transfer Protocol (“HTTP”), or another standard or proprietary network communication protocol. A message may, for example, be sent or broadcast to each of a pre-determined set of clients, such as manually entered clients, a database of clients, clients obtained from a server or web site, or another set of clients.

In one embodiment, a spooler, such as spooler 44 of FIG. 2, is enabled to provide the broadcast to one or more clients, such as client 50, over network 64. Alternatively, in another embodiment, a print processor, such as print processor 56 of FIG. 2, is enabled to provide a broadcast to one or more clients, such as client 40, over network 64. The broadcast provided across a network by a spooler or a print processor may be used for a variety of purposes in managing and/or processing a print job, as will be further explained below.

One such purpose for transmitting a broadcast is to register a client in a distributed management of print jobs. In accordance with the present invention, a client may broadcast a registration message to one or more clients across a network. This registration message identifies the intent of broadcasting client to participate in a distributed management and spooling of print jobs.

In one embodiment, the content of the registration message is composed of a command field indicating an intent to register, an identification of the broadcasting client, and a list of printing devices for the broadcasting client to participate in the management thereof. The following is an example of a broadcast to register a client in a distributed management of print jobs:

CMD = REGISTER
Client DNS Name
Client IP Address
Printer DNS Name

Printer 1
. . .
Printer N

Printer IP Address

Printer 1
. . .
Printer N

Another purpose for transmitting a broadcast across the network is to indicate an intent to despool a print job. When a user at a client initiates a print job directed to one or more printing devices on the network, a broadcast is transmitted to other clients registered to participate in managing print jobs to indicate the client's intent to despool print data to the intended printing device(s). This type of broadcast is utilized to identify which client(s) participate in managing the despooling of print data to the identified printing device(s) and whether the print data may be despooled without delay.

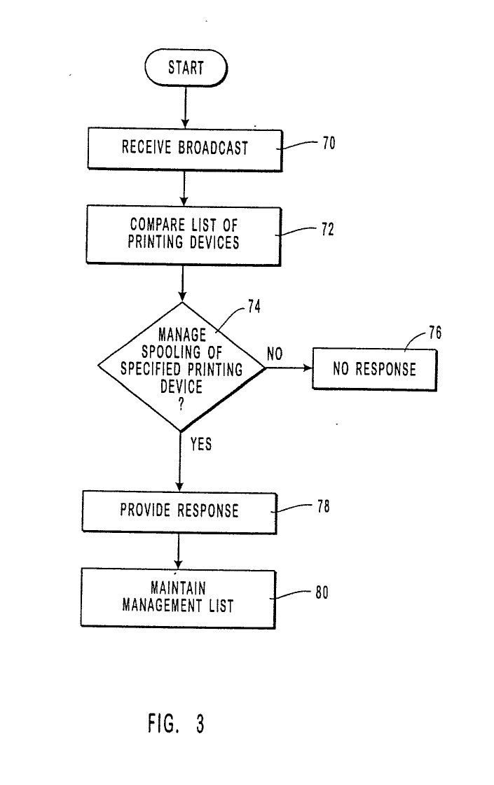

With reference to FIG. 3, a flow chart is illustrated that provides an example of how each of the receiving clients responds to such a broadcast across the network. In FIG. 3, execution begins at step 70, where another client on the network receives the broadcast that indicates an intent to despool print data to one or more network printing devices. At step 72, the receiving client compares the printing device(s) identified in the broadcast with a list of printing devices for which the receiving client participates in management responsibilities.

At decision block 74 a determination is made as to whether or not the receiving client participates in the management of print data despooled to the identified printing device(s) of the broadcast. If it is determined that the receiving client does not participate in the management of print data despooled to the identified printing device(s), execution proceeds to step 76, where no response is returned to the sending client. Alternatively, if it is determined at decision block 74 that the receiving client participates in the management of print data despooled to at least one of the identified printing devices, execution proceeds to step 78, where the receiving client provides a response to the broadcasting client.

The response sent at step 78 may be sent directly to the broadcasting client (e.g. peer to peer) using the broadcasting client's DNS Name, IP Address, or other network identification in order to establish a connection. The response may include a register message that identifies the printing device(s) that are identified in the print job for which the receiving client participates in management thereof.

The response provided at step 78 may indicate (1) that the receiving client has no objection to the immediate despooling of print data to the identified printing device(s); (2) that the receiving client denies the immediate despooling of print data; or (3) that a conflict must be resolved in order to provide an immediate despooling of print data. By way of example, the first type of response, which indicates that the receiving client has no objection to an immediate despooling of print data, occurs when no print job is currently queued for or being despooled to the identified printing device(s), or when the client responding to the broadcast has a print job of a lower priority that is queued for the identified printing device(s). The second type of response, which denies the immediate despooling of print data, occurs when the client responding to the broadcast is in the process of despooling a print job to the specified printing device(s), when the responding client has administrative authority (e.g. it is the master) over the broadcasting client, or when the client responding is managing a print job at a higher priority. The third type of response, which indicates that a conflict must be resolved in order to provide an immediate despooling of print data, occurs when the client responding to the broadcast is managing a print job that is previously queued for the printing device(s) identified in the broadcast and has the same priority as the broadcasting client's print job, or when the responding client has administrative authority (e.g. is the master) over the broadcasting client and changes the priority of the broadcasting client's print job.

Thus, once a response is provided at step 78, execution proceeds to step 80 to maintain one or more management lists. In one embodiment, both the broadcasting and receiving clients independently maintain lists that identify the clients that are participating in managing network printing devices, and the print queues corresponding to the printing devices that are being managed, as will be further explained below.

In the instance where the broadcast indicates an intent to despool print data, such as the broadcast received in step 70 of FIG. 3, the content of a broadcast may include, for example, a command field indicating an intent to despool, an identification of the sending client, an identification of the print job that is to be despooled, and the print queue information. Thus, the following is an example of a broadcast that indicates an intent to despool print data:

CMD=INTENT_TO_DESPOOL
Client DNS Name
Client IP Address
Print Job ID
DNS Name

Printer 1
. . .
Printer N

IP Address

Printer 1
. . .
Printer N

Document Name

Document 1
. . .
Document N

Owner
Submission Time
Size of the Spool Data
Number of Pages
Number of Sheets
Assigned Priority

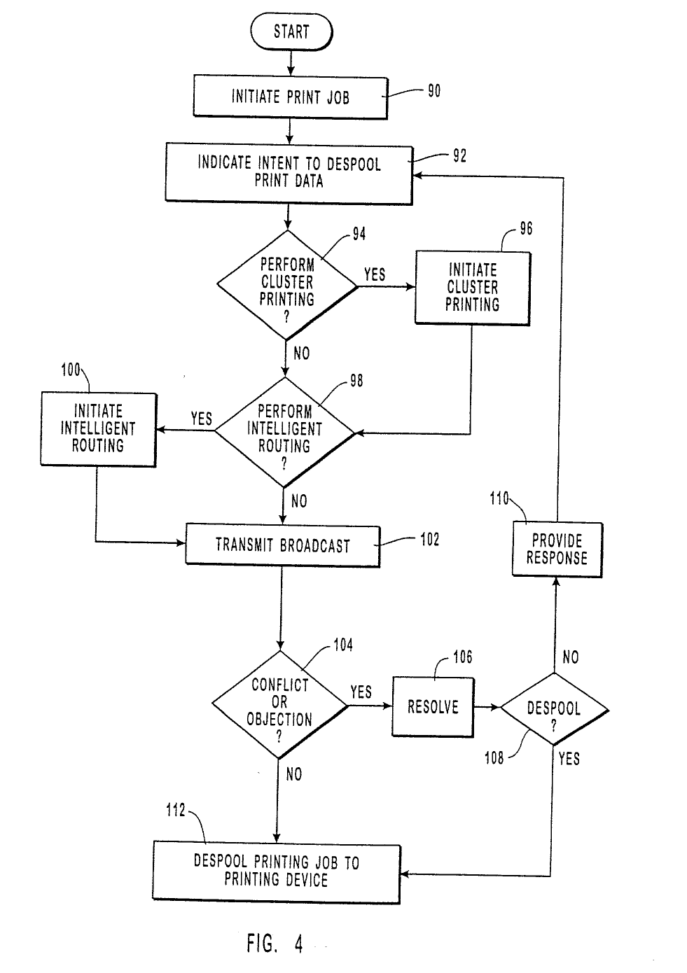

With reference to FIG. 4, a flow chart is illustrated that provides a representative method for using the broadcast as part of a process for performing a print job across a network. In FIG. 4, execution begins at step 90, where a user at a client of a networked computer system initiates a print job. Typically, the print job is initiated through the use of a software application, or by an automated or background process. At step 92 a user indicates an intent to despool the print job to one or more printing devices on the network.

The user may further determine how the print job is to be processed. For example, the print data may be sent to a default printing device or to a first available printing device. Alternatively, the user may elect to perform cluster printing, which is to split the print job or copies thereof among a group of printers, and/or may elect to perform intelligent routing, which is to despool the print data to the one or more printing devices having the greatest preference in a group of printers. Thus, at decision block 94 a determination is made as to whether or not to perform cluster printing. If it is determined that cluster printing is not to be performed, execution proceeds directly to decision block 98. Alternatively, if it is determined at decision block 94 that cluster printing is to be performed, step 96 initiates cluster printing by indicating that the print data is to be despooled to a cluster of printing devices to process the print job. Execution then proceeds to decision block 98, where a determination is made as to whether or not to perform intelligent routing. If it is determined that intelligent routing is not to be performed, execution proceeds directly to step 102. Alternatively, if it is determined at decision block 98 that intelligent routing is to be performed, step 100 initiates the intelligent routing by indicating the one or more printers to which the print data is to be despooled. Execution then proceeds to step 102.

At step 102, the broadcast indicating an intent to despool is transmitted across the network to the one or more clients participating in distributed management of print jobs. As provided above, upon receiving the broadcast, the receiving clients respond appropriately, which may include providing no response. As also provided above, if a response is provided it may indicate (1) that the receiving client has no objection to the immediate despooling of print data to the identified printing device(s); (2) that the receiving client denies the immediate despooling of print data; or (3) that a conflict must be resolved in order to provide an immediate despooling of print data. Thus, at decision block 104 a determination is made as to whether a receiving client returned a response indicating a conflict or an objection. If no conflict or objection was returned, the print data is despooled at step 112.

Alternatively, if it is determined at decision block 104 that a conflict or an objection was returned, a resolution is attempted at step 106 and a decision is made at decision block 108 as to whether or not the print data may now be despooled to the indicated printing device(s). If it is determined at decision block 108 that the print data may not be despooled a response is provided to the user at step 110 and execution returns back to step 92 to indicate an intent to despool print data relating to another print job. Alternatively, if it is determined at decision block 108 that the print data may be immediately despooled, the print data is despooled to the identified printing device(s) at step 112.

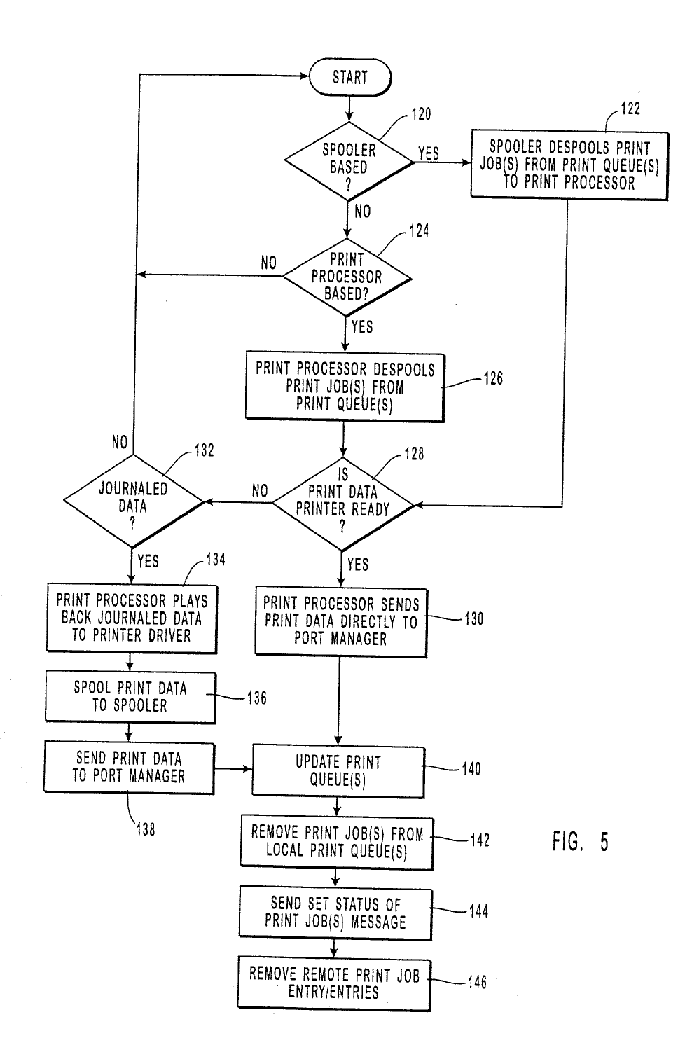

With reference now to FIG. 5, a flow chart is illustrated that provides a representative embodiment for despooling print data across the network. A spooler or print processor may initiate the despooling of print data. Thus, in FIG. 5 execution begins at decision block 120 for a determination as to whether or not the despooling of the print data is spooler based. If it is determined at decision block 120 that the despooling of print data is spooler based, a spooler (e.g. spooler 44 of FIG. 2 when client 40 broadcast the intent to despool print data) despools the specified print data from a print queue (e.g. print queue 46 of FIG. 2) to a print processor (e.g. print processor 46 of FIG. 2) at step 122 and execution proceeds to decision block 128.

Alternatively, if it is determined at decision block 120 that the despooling of print data is not spooler based, execution proceeds to decision block 124 for a determination as to whether or not the despooling of print data is based on a print processor. If it is determined that the despooling is not based on a print processor, execution returns back to start. Alternatively, if it is determined that the despooling is based on a print processor, the print processor (e.g. print processor 56 of FIG. 2 when client 50 broadcast the intent to despool print data) despools the specified print job from the print queue (e.g. print queue 55 of FIG. 2) at step 126 and execution proceeds to decision block 128.

At decision block 128, a determination is made as to whether or not the print data is in a printer ready (e.g., a raw or unprocessed) format. If the print data is in a printer ready format, the print processor of the client that broadcast the intent to despool sends the print data at step 130 directly to the port manager(s) of the printing device(s) specified for the processing the print job. Execution then proceeds to step 140.

Alternatively, if it is determined at decision block 128 that the print data is not in a printer ready format, execution proceeds to decision block 132, where a determination is made as to whether or not the print data is in a journaled format, such as an enhanced metafile format. If the print data is not in a journaled format, execution returns back to start. Alternatively, if the print data is in a journaled format, the print processor of the client that broadcast the intent to despool print data plays back the journaled data at step 134 to the respective local printer driver(s), which render the print data. The print data is then spooled to the local spooler at step 136 and sent to the port manager(s) of the specified printing device(s) at step 138. Execution then proceeds to step 140.

Once the print job has been despooled, the local spooler or print processor updates the print queue entries at step 140 to indicate that the status of the print job has changed from “QUEUED” to “DESPOOLED.” Once the print job has completed printing, the local spooler or print processor removes the local print queue entry at step 142 to indicate that the status of the print job has changed from “DESPOOLED” to “COMPLETED.” At step 144, a broadcast is sent to set the status of the print job to clients on the network so that the receiving clients at step 146 may remove their, if any, remote print job entry in their respective local print queue(s).

Thus, another purpose for transmitting a broadcast across a network is to set the status of a print job. As provided above, a client sends a broadcast to one or more other clients to set or update the status of a print job that is queued or despooled on the receiving client's local print queue. Similarly, a broadcast may be used to get the status of a print job. The content of the broadcast may include a command field indicating a desire to set/get the status of a print job, an identification of the particular client, and an identification of one or more print jobs. The following is an example of a broadcast for getting the status of a print job:

CMD=GET_STATUS_PRINT JOBS
Client DNS Name
Client IP Address
Print Job IDs

Job 1
. . .
Job N

Print Job Name

Job 1
. . .
Job N

(While the example above is for getting the status of a print job, a similar broadcast may be sent for setting the status of a print job.) The client that receives the broadcast responds by providing the status (e.g. queued, despooling, or completed) of the print job. The following is an example of a response that provides the current status of a particular print job:

State: QUEUED, DESPOOLING, COMPLETED
PRIORITY: <value>
SPOOL SIZE: <value>
No. of Pages: <value>
No. of Sheets: <value>

Upon receipt of the response providing the current status of the print job, the client updates any remote print job entries on its local print queue.

Similarly, in order to manage the processing of print jobs, another purpose for transmitting a broadcast across the network include to set or to get the status of one or more network printing devices. A client may send a broadcast to one or more clients to set or get the status of one or more of the network printing devices. In one embodiment, the content of the broadcast includes a command field indicating a desire to set or get the status of one or more network printing devices, an identification of a particular client, and the identification of the one or more printing devices. Thus, the following is an example of a broadcast to get the status of a network printing device:

CMD=GET_STATUS_PRINTER
Client DNS Name
Client IP Address
DNS Name

Printer 1
. . .
Printer N

IP Address

Printer 1
. . .
Printer N

(While the example above is for getting the status of a printing device, a similar broadcast may be sent for setting the status of a printing device.) In turn the client receiving the broadcast provides a response that identifies the status of the printing device(s). However, if the client receiving the broadcast is unable to obtain the status of the network printing device(s), the response returned indicates that the status of the printing device(s) is UNKNOWN. Upon receipt of the response, the client that sent the broadcast updates its printer queue information for the specified printing devices.

Another purpose for transmitting a broadcast across the network is to request print queue information. A client may send a broadcast to one or more other clients on the network to update the status of all print jobs that are queued on the local print queues of the receiving clients. In one embodiment, the content of the message includes a command field indicating an intent to obtain print queue information, an identification of the particular clients, and the identification of the printing devices corresponding to the printing queues. The following is an example of a broadcast that requests print queue information:

CMD=GET_STATUS_PRINTQUEUE
Client DNS Name
Client IP Address
DNS Name

Printer 1
. . .
Printer N

IP Address

Printer 1
. . .
Printer N

The client receiving the broadcast for print queue information sends back a response that relates to all print jobs for all specified print queues that are local to the receiving client. Such print jobs include print jobs that are queued or are being despooled locally by the receiving client, and print jobs that are listed locally at the receiving client but are being queued or despooled remotely on other clients. In one embodiment, the sending and receiving clients maintain print job information locally at their respective print queues. The following is an example of the content of a broadcast for print queue information:

| Field | Type | Example |
|---|---|---|
| Printer DNS Name | String | Sharp 507 |
| Printer IP Address | IP Address | 000.000.000.000 |
| Document Name | String | 2page.doc |
| Owner | String | Bob Smith |
| Time Stamp | Time | 00:00:00 |
| Spool Data Size | Integer (Mbytes) | >0 |
| No. of Pages | Integer | >0 |
| No. of Sheets | Integer | >0 |
| Priority | Integer | −N < = 0 < = N |

Another purpose for transmitting a broadcast across the network is to request for a print queue change. In such a broadcast, the sending client is requesting either to obtain administrative authority from the receiving client or to change the print job queue state on the receiving client. In one embodiment, all clients are initially presumed to be non-administrative, and only manage or alter information on their local print queue(s). Thus, a client sending a broadcast may request administrative authority on remote print queue(s), printing device(s), receiving client(s), and on the global managerial system configuration.

A variety of algorithms may be used to determine when to grant or to deny a request for administrative authority. Such algorithms include, a discretionary access algorithm, a round robin algorithm, or another type of algorithm.

A client receiving a broadcast that requests a print queue change provides one of two responses. A first response that may be returned is that the receiving client has no objection to granting administrative authority. A second response that may be returned is that the receiving client denies granting administrative authority. In one embodiment, the response returned is on a per item basis. For example, a client provides a broadcast that requests administrative authority over two of the receiving client's local print queue(s). The receiving client may respond on a per item basis to the broadcast, such as by granting administrative authority over one print queue and denying authority over the other.

In one embodiment, if the request is for administrative authority is over a printing device, all clients receiving the broadcast that have one or more print queue(s) for the printing device will respond. Similarly, if the request is for global administrative authority, all clients that receive the broadcast will respond.

Thus, as discussed herein, embodiments of the present invention embrace systems and methods for managing and processing print jobs in a networked computer environment without using a print server. In managing and processing print jobs, a broadcast is utilized by being transmitted across a network for a variety of purposes, including: to register a client into a distributed management of print jobs; to indicate an intent to despool a print job; to set or check the status of a despooled print job; to set or get the status of a particular printing device; to request print queue information; and/or to request a print queue change. Each client receiving the broadcast responds accordingly, which may include no response.

While the methods and processes of the present invention have proven to be particularly useful in the area of managing and processing print job(s), those skilled in the art can appreciate that the methods and processes can be used in a variety of different applications to perform peer to peer processes across a networked environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A system that provides distributed management of one or more print jobs within a networked computer environment, the system comprising:
a network;
a plurality of client computer devices connected to the network, wherein the plurality of client computer devices are configured to participate in bi-directional communication across the network;
a printing device for processing a print job initiated at one of the plurality of client computer devices, wherein the printing device is connected to the network;
a broadcast sent from a first client computer device to a second client computer device across the network, wherein the first and second client computer devices are of the plurality of computer devices, and wherein at least one of the first and second client computer devices participates in a centralized management of the print job.

2. A system as recited in claim 1, wherein the broadcast indicates an intent of the first client computer device to participate in a distributed management of a print job.

3. A system as recited in claim 1, wherein the broadcast indicates an intent to despool print data to the printing device.

4. A system as recited in claim 1, wherein the broadcast indicates an intent to set a status for the print job.

5. A system as recited in claim 1, wherein the broadcast indicates an intent to get a current status for the print job.

6. A system as recited in claim 1, wherein the broadcast indicates an intent to set a status on the printing device.

7. A system as recited in claim 1, wherein the broadcast indicates an intent to get a current status for the printing device.

8. A system as recited in claim 1, wherein the broadcast provides a request for print queue information.

9. A system as recited in claim 1, wherein the broadcast provides a request for a print queue change.

10. A system as recited in claim 1, wherein the broadcast provides a request for administrative authority.

11. A system as recited in claim 10, wherein the request for administrative authority is over at least one of:
(i) a print queue;
(ii) a printing device;
(iii) a computer device; and
(iv) a global managerial system configuration.

12. In a system that includes a plurality of client computer devices connected to a printing device via a network, a method for processing a print job, the method comprising the steps for:
initiating a first print job at a first client computer device;
transmitting a first broadcast across the network from the first client computer device to a second client computer device, wherein the first broadcast indicates an intent to despool print data to the printing device that corresponds to the first print job;
receiving a first response to the first broadcast from the second client computer device; and
despooling the print data corresponding to the first print job directly from the first client computer device to the printing device to process the first print job.

13. A method as recited in claim 12, wherein the step for initiating includes the step for determining whether to perform cluster printing, and wherein if the cluster printing is to be performed, utilizing the printing device in performing the cluster printing.

14. A method as recited in claim 12, wherein the step for initiating includes the step for determining whether to perform intelligent routing, and wherein if the intelligent routing is to be performed, utilizing the printing device in performing the intelligent routing.

15. A method as recited in claim 12, wherein the step for receiving includes the step for determining whether the first response includes a conflict for despooling the print data to the printing device, and wherein if the conflict is included in the first response, performing the step for resolving the conflict.

16. A method as recited in claim 12, wherein the step for receiving includes the step for determining whether the first response includes an objection to despooling the print data to the printing device, and wherein if the objection is included in the first response, performing the step for resolving the objection.

17. A method as recited in claim 12, wherein the step for receiving includes receiving no response from the second client computer device.

18. A method as recited in claim 12, wherein the step for despooling includes using a spooler to despool the print job from at least one print queue to a print processor, and wherein the spooler and the print processor are local to the first client computer device.

19. A method as recited in claim 12, wherein the step for despooling includes using a print processor to despool the print job from at least one print queue, and wherein the print processor is local to the first client computer device.

20. A method as recited in claim 12, wherein prior to performing the step for transmitting the first broadcast, performing the steps for:
initiating a second print job at a third client computer device;
ordering the first broadcast and a second broadcast on a queue; and
managing the queue.

21. A method as recited in claim 20, wherein the step for managing is performed by at least one of:
(i) a print driver; and
(ii) a print assistant.

22. A method as recited in claim 20, further comprising the steps for:
transmitting the second broadcast across the network from the third client computer device to the second client computer device, wherein the second broadcast indicates an intent to despool print data to the printing device that corresponds to the second print job;
receiving a second response to the second broadcast from the second client computer device; and
despooling the print data corresponding to the second broadcast directly from the third client computer device to the printing device to process the second print job.

23. A method as recited in claim 22, wherein the third client computer device is the first client computer device.

24. A method as recited in claim 12, wherein the step for despooling the print data further includes the steps for:
updating one or more print queues; and
setting a status of the first print job.

25. A method as recited in claim 24, wherein the step for despooling the print data further includes the steps for:
removing the first print job from one or more local print queues; and
removing a remote entry of the first print job from a remote print queue.

26. A method as recited in claim 25, wherein if the print data corresponding to the first print job is in a printer ready format, the step for despooling the print data further includes the step for using a print processor to send the print data to a port manager.

27. A method as recited in claim 25, wherein if the print data corresponding to the first print job is in a journaled format, the step for despooling the print data further includes the steps for:
using a print processor to play back the journaled data to a printer driver;
spooling the print data to a spooler; and
sending the print data to a port manager.

28. A computer program product for implementing within a networked computer system a method for processing a print job, the computer program product comprising:
computer readable medium for providing computer program code means utilized to implement the method, wherein the computer program code means is comprised of executable code for implementing the steps for:
transmitting a broadcast across a network from a first client computer device to a second client computer device, wherein the broadcast indicates an intent to despool print data corresponding to a print job to a printing device;
receiving a response to the broadcast from the second client computer device; and
despooling the print data directly from the first client computer device to the printing device to process the print job.

29. A computer program product as recited in claim 28, wherein the step for receiving a response includes the steps for:
determining whether the response includes a conflict from the client computer device to despool the print data to the printing device, wherein if the conflict is included in the response, resolving the conflict; and
determining whether the response includes an objection from the client computer device to despool the print data to the printing device, wherein if the objection is included in the response, resolving the objection.

30. A computer program product as recited in claim 28, wherein the step for receiving a response includes receiving no response from the second client computer device.

31. A computer program product as recited in claim 28, wherein the step for despooling the print data includes using a spooler to despool the print job from at least one print queue to a print processor.

32. A computer program product as recited in claim 28, wherein the step for despooling the print data includes using a print processor to despool the print job from at least one print queue.
